(19) United States
(12) Patent Application Publication
(10) Pub. No.: US 2026/0342853 A1
(43) Pub. Date: Oct. 29, 2026

(54) PROCESSING SECURITY-RELATED CONFIGURATIONS OF CLOUD RESOURCES USING GENERATIVE ARTIFICIAL INTELLIGENCE

(71) Applicant: Dell Products L.P., Round Rock, TX (US)

(72) Inventors: Geetha Venkatesan, Bangalore (IN); Gandhirajan N, Yelachenahalli (IN); Prasad Gali, Bangalore (IN); Sunil Kumar Patra, Bengaluru (IN); Ankit Ramesh Lakhotia, Bangalore (IN)

(21) Appl. No.: 19/187,791

(22) Filed: Apr. 23, 2025

(51) Int. Cl. H04L 9/40

(52) U.S. Cl. CPC H04L 63/20

(57) ABSTRACT

Methods, apparatus, and processor-readable storage media for processing security-related configurations of cloud resources using generative artificial intelligence are provided herein. An example computer-implemented method includes obtaining data-related prompts pertaining to a cloud computing environment resource; accessing data, pertaining to security-related configurations of the cloud computing environment resource, from the cloud computing environment using the data-related prompts; obtaining information attributed to the security-related configurations of the cloud computing environment resource; generating, using one or more large language models, a security-related configuration assessment of the cloud computing environment resource based on the accessed data and the obtained information; determining, based on processing the security-related configuration assessment using generative artificial intelligence, one or more automated mitigation-related actions related to the security-related configurations of the cloud computing environment resource; and automatically modifying the security-related configurations of the cloud computing environment resource by performing at least part of the automated mitigation-related actions.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

The security configuration of resources within cloud computing environments plays an increasingly important role in a multitude of contexts. For example, misconfigurations of resources can result in exploits, service outages, data leaks, etc. However, conventional cloud management approaches typically include reactive processes involving resource-intensive and error-prone methods carried out after security issues have already arisen.

### SUMMARY

Illustrative embodiments of the disclosure provide techniques for processing security-related configurations of cloud resources using generative artificial intelligence.

An example computer-implemented method includes obtaining one or more data-related prompts pertaining to at least one cloud computing environment resource, and accessing data, pertaining to one or more security-related configurations of the at least one cloud computing environment resource, from the at least one cloud computing environment using at least a portion of the one or more data-related prompts. The method also includes obtaining information, designated in at least one data structure associated with the at least one cloud computing environment, attributed to the one or more security-related configurations of the at least one cloud computing environment resource, and generating, using one or more large language models, at least one security-related configuration assessment of the at least one cloud computing environment resource based at least in part on the accessed data and the obtained information. Additionally, the method includes determining, based at least in part on processing the at least one security-related configuration assessment using one or more generative artificial intelligence techniques, one or more automated mitigation-related actions related to at least a portion of the one or more security-related configurations of the at least one cloud computing environment resource. Further, the method also includes automatically modifying the at least a portion of the one or more security-related configurations of the at least one cloud computing environment resource by performing at least part of the one or more automated mitigation-related actions.

Illustrative embodiments can provide significant advantages relative to conventional cloud management approaches. For example, problems associated with reactive processes which are resource-intensive and error-prone are overcome in one or more embodiments through processing security-related configurations of cloud computing environment resources using generative artificial intelligence and automatically performing configuration mitigation actions related thereto.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for processing security-related configurations of cloud resources using generative artificial intelligence in an illustrative embodiment.

FIG. 2 shows an example system framework in an illustrative embodiment.

FIG. 3 shows example pseudocode for extracting configuration files from a cloud computing environment in an illustrative embodiment.

FIG. 4 shows example pseudocode for invoking a large language model (LLM) application programming interface (API) by passing required prompts and configuration file content in an illustrative embodiment.

FIG. 5 shows example pseudocode for performing automated configuration mitigation actions in an illustrative embodiment.

FIG. 6 shows example pseudocode for a presenting a vulnerability assessment generated by a security tool in an illustrative embodiment.

FIG. 7 shows example pseudocode for presenting a vulnerability assessment generated by a generative artificial intelligence agent using at least one LLM in an illustrative embodiment.

FIG. 8 is a flow diagram of a process for processing security-related configurations of cloud resources using generative artificial intelligence in an illustrative embodiment.

FIGS. 9 and 10 show examples of processing platforms that may be utilized to implement at least a portion of an information processing system in illustrative embodiments.

### DETAILED DESCRIPTION

Illustrative embodiments will be described herein with reference to example computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

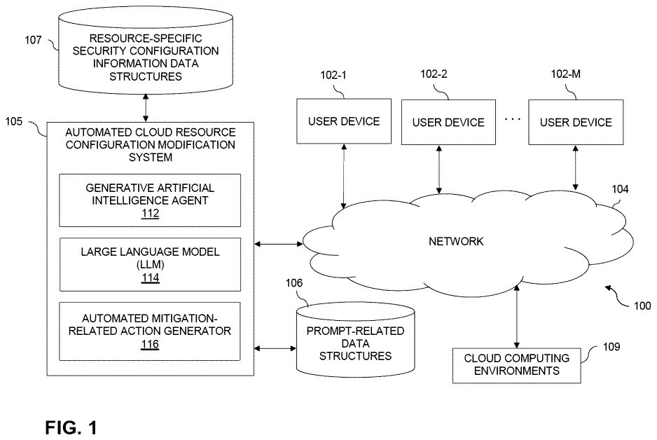

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment. Also coupled to network 104 is automated cloud resource configuration modification system 105 and one or more cloud computing environments 109 (e.g., one or more public cloud computing environments and/or one or more private cloud computing environments).

The user devices 102 may comprise, for example, mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, the automated cloud resource configuration modification system 105 can have one or more prompt-related data structures 106 configured to store data pertaining to various prompts related to obtaining and/or processing information from one or more cloud computing environments.

By way merely of example, an example system prompt can include the following: “You are a security expert specializing in cloud infrastructure. Your task is to analyze cloud computing platform resource manager templates for potential security vulnerabilities. Given a given template, identify any potential security risks or misconfigurations, and provide recommendations for mitigating these risks. Focus on aspects such as access controls, network configurations, encryption settings, and adherence to best practices for cloud security.”

By way of further example, another example prompt can include the following: “Analyze the following cloud computing platform resource manager template for potential security vulnerabilities. Specifically, list the potential security risks related to publicNetworkAccess.”

Also, as depicted in FIG. 1, the automated cloud resource configuration modification system 105 can have one or more resource-specific security configuration information data structures 107 configured to store data pertaining to various configurations associated with one or more cloud computing environments. The term “data structure,” as used herein, is intended to be broadly construed, so as to encompass, for example, a wide variety of different types of tables, arrays, graphs, trees, linked lists, and additional or alternative data relation mechanisms, as well as portions or combinations thereof. Accordingly, a given data structure can comprise a combination of multiple smaller data structures, possibly of different types, or a portion of a larger data structure. Numerous other arrangements are possible.

The prompt-related data structures 106 and/or resource-specific security configuration information data structures 107 in the present embodiment are implemented using one or more storage systems associated with the automated cloud resource configuration modification system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with the automated cloud resource configuration modification system 105 are one or more input-output devices, which illustratively comprise keyboards, displays or other types of input-output devices in any combination. Such input-output devices can be used, for example, to support one or more user interfaces to the automated cloud resource configuration modification system 105, as well as to support communication between the automated cloud resource configuration modification system 105 and other related systems and devices not explicitly shown.

Additionally, the automated cloud resource configuration modification system 105 in the FIG. 1 embodiment is assumed to be implemented using at least one processing device. Each such processing device generally comprises at least one processor and an associated memory, and implements one or more functional modules for controlling certain features of the automated cloud resource configuration modification system 105.

More particularly, the automated cloud resource configuration modification system 105 in this embodiment can comprise a processor coupled to a memory and a network interface.

The processor may comprise, for example, a microprocessor, an application-specific integrated circuit (ASIC), a system-on-chip (SOC), a field-programmable gate array (FPGA), a central processing unit (CPU), a graphics processing unit (GPU), a neural processing unit (NPU), a data processing unit (DPU), a tensor processing unit (TPU), an arithmetic logic unit (ALU), a digital signal processor (DSP), and/or other similar processing device components, as well as other types and arrangements of processing circuitry, in any combination. At least a portion of the functionality of at least one artificial intelligence system and its associated artificial intelligence algorithms provided by one or more processing devices as disclosed herein can be implemented using such circuitry.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the automated cloud resource configuration modification system 105 to communicate over the network 104 with the user devices 102, and illustratively comprises one or more conventional transceivers.

The automated cloud resource configuration modification system 105 further comprises a generative artificial intelligence agent 112, at least one LLM 114, and an automated mitigation-related action generator 116.

In at least one embodiment, the generative artificial intelligence agent 112 is trained and implemented to perform a number of tasks related to detecting and mitigating resource-related misconfigurations in cloud computing environments 109. Also, in such an embodiment, the at least one LLM 114 (e.g., at least one generative pre-trained transformer) can generate security configuration evaluation information based at least in part on information obtained by the generative artificial intelligence agent 112 and information derived from resource-specific security configuration information data structures 107. Further, in one or more embodiments, the automated mitigation-related action generator 116 initiates at least one appropriate automated mitigation process on at least a portion of cloud computing environments 109, wherein such an automated mitigation process involves mitigation actions determined by the generative artificial intelligence agent 112 in connection with security configuration evaluation information generated by the at least one LLM 114.

It is to be appreciated that this particular arrangement of elements 112, 114 and 116 illustrated in the automated cloud resource configuration modification system 105 of the FIG. 1 embodiment is presented by way of example only, and alternative arrangements can be used in other embodiments. For example, the functionality associated with elements 112, 114 and 116 in other embodiments can be combined into a single module, or separated across a larger number of modules. As another example, multiple distinct processors can be used to implement different ones of elements 112, 114 and 116 or portions thereof.

At least portions of elements 112, 114 and 116 may be implemented at least in part in the form of software that is stored in memory and executed by a processor.

It is to be understood that the particular set of elements shown in FIG. 1 for processing security-related configurations of cloud resources using generative artificial intelligence involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, two or more of automated cloud resource configuration modification system 105, prompt-related data structures 106, resource-specific security configuration information data structures 107, and cloud computing environments 109 can be on and/or part of the same processing platform.

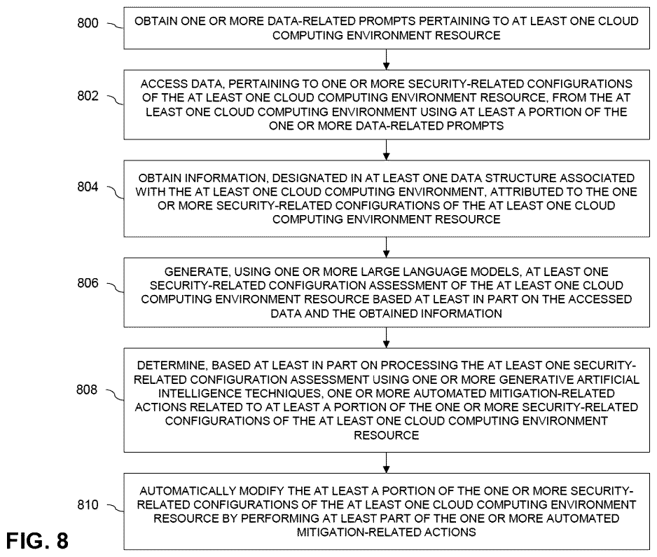

An example process utilizing elements 112, 114 and 116 of an example automated cloud resource configuration modification system 105 in computer network 100 will be described in more detail with reference to the flow diagram of FIG. 8.

Accordingly, at least one embodiment includes processing security-related configurations of cloud resources using generative artificial intelligence. By way of example, such an embodiment can include focusing on networking and access control configurations in connection with various resources such as, e.g., event hubs and storage accounts in public clouds. As further detailed herein, such an embodiment includes leveraging generative artificial intelligence techniques to proactively monitor one or more security configurations of both newly created resources and existing resources in one or more cloud computing environments. Such an embodiment includes automating the mitigation of one or more security misconfigurations by leveraging generative artificial intelligence capabilities in conjunction with one or more knowledge bases and/or data structures related to the cloud computing environment in question. Based at least in part on the security analysis of specific resources using generative artificial intelligence, a generative artificial intelligence agent identifies potential mitigation steps by using one or more prompts accordingly. Based at least in part on the listed mitigation steps, the generative artificial intelligence agent selects the mitigation step which is more relevant to the user and/or corresponding enterprise based on data derived from at least one knowledge base (e.g., an enterprise-specific knowledge base).

Also, one or more embodiments can include generating one or more alerts and/or notifications pertaining to misconfigurations and/or related security threats, wherein such alerts and/or notifications can be output to at least one user device and/or system for further intervention. Additionally or alternatively, in at least one embodiment, such alerts and/or notifications can be leveraged to initiate and/or perform one or more automated actions directed at remediating at least a portion of the misconfigurations and/or related security threats in question. For example, if generative artificial intelligence is leveraged and identifies “public access enabled” as one of the potential security threats for a given resource, the agent leverages generative artificial intelligence to list out mitigation steps for that security threat. If the generative artificial intelligence identifies “disabling public access” as the mitigation, the agent implements the corresponding mitigation steps and searches the enterprise knowledge base to enable secured access which includes enabling private link for resource access.

Accordingly, one or more embodiments include detecting resource-related misconfigurations within a cloud computing environment using generative artificial intelligence techniques (e.g., one or more generative pretrained transformers (GPTs), one or more pretrained and/or instruction-tuned generative models, etc.) in conjunction with information from one or more related knowledge bases and/or data structures, and automatically initiating one or more mitigation actions in response to the detected resource-related misconfigurations. Also, such an embodiment includes enabling customization capabilities to plug in one or more enterprise-specific mitigation steps and/or actions in connection with particular detected resource-related misconfigurations. Such a plugin can be implemented and/or carried out in the corresponding enterprise knowledge base. For example, in case of a misconfiguration related to public network access, generative artificial intelligence can be leveraged to provide steps related to disabling public network access. Also, the corresponding enterprise knowledge base provides additional information on how to work out the network access in a secured manner by enabling a private link to the resource. Such a plugin can be embedded in the corresponding enterprise knowledge base for the specific resource type along with one or more enterprise-approved security and access policies.

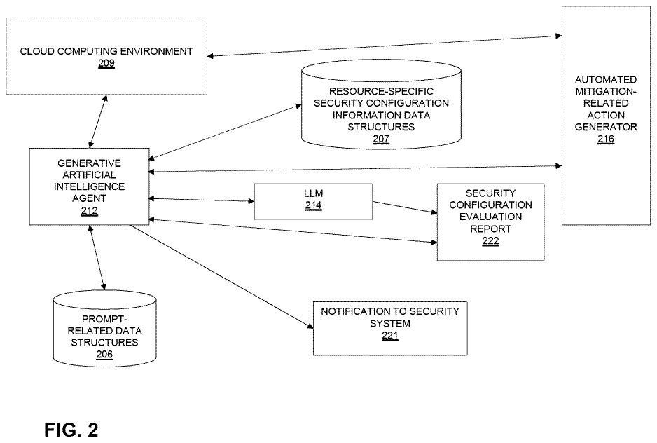

FIG. 2 shows an example system framework in an illustrative embodiment. By way of illustration, FIG. 2 depicts an example system framework for configuring and/or training at least one generative artificial intelligence agent 212 (e.g., as part of automated cloud resource configuration modification system) to perform a number of tasks related to detecting and mitigating resource-related misconfigurations in cloud computing environment 209. For example, in at least one embodiment, such a generative artificial intelligence agent 212 obtains and/or pulls one or more prompts, related to a particular resource in a given cloud computing environment 209, from prompt-related data structures 206. When the generative artificial intelligence agent 212 is triggered using a continuous integration/continuous delivery (CI/CD) pipeline and/or scripts, the targeted resource type along with subscription details will be passed to the generative artificial intelligence agent 212 from which it understands which resource type specific prompts it needs to pull. Additionally, in such an embodiment, the generative artificial intelligence agent 212 obtains and/or pulls one or more configuration files (YAML templates, Azure resource manager (ARM) templates, CloudFormation templates, etc.) of the particular resource from the given cloud computing environment 209, and processes and/or searches standard and/or designated configuring information for the particular resource from resource-specific security configuration information data structures 207.

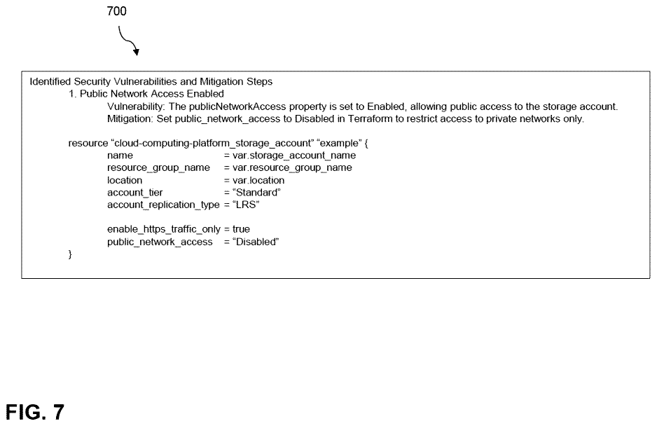

Additionally, in one or more embodiments, the generative artificial intelligence agent 212 collates the prompt information, the resource configuration file content, and the resource-specific standard configuration information, and passes such collated information to at least one LLM 214 via at least one API. The at least one LLM 214 can then generate a security configuration evaluation report 222 (such as, for example, further detailed in connection with FIG. 7) based at least in part on the prompts as well as the resource-specific standard configuration information. The generative artificial intelligence agent 212 analyzes the security configuration evaluation report to detect one or more security misconfigurations associated with the particular resource, and leverages one or more generative artificial intelligence techniques to determine and/or infer one or more mitigation steps to remedy the security misconfigurations, which can then be output to and executed automatically by automated mitigation-related action generator 216.

In at least one embodiment, the generative artificial intelligence agent 212 detects misconfigurations and infers corresponding mitigation steps based at least in part on the security evaluation report. The steps to be executed for mitigations can be inferred by the generative artificial intelligence agent 212 using subsequent prompts to generative artificial intelligence, which lists out the command-line interface (CLI) commands and/or Terraform scripts to be executed to mitigate the misconfigurations. For example, for a misconfiguration related to public network access, the generative artificial intelligence agent 212 infers the CLI commands to disable public network access using subsequent prompts to generative artificial intelligence.

Additionally, in one or more embodiments, the automated mitigation-related action generator 216 initiates at least one appropriate automated mitigation process on the particular cloud computing environment 209, wherein the automated mitigation process involves at least a portion of the one or more mitigation steps determined (by the generative artificial intelligence agent 212) based at least in part on the security configuration evaluation report 222. Upon successful initiation and/or completion of the automated mitigation process, the generative artificial intelligence agent 212 can input information pertaining to the appropriate action(s) taken into the resource-specific security configuration information data structures 207 to update at least a portion of the data structures. In at least one embodiment, if no appropriate automated mitigation action is determined or available for execution, the generative artificial intelligence agent 212 can trigger the generation and output of at least one notification 221 to a given system or security team, requesting and/or instructing intervention to mitigate the one or more security threats.

Accordingly, in at least one embodiment, a generative artificial intelligence agent can process and/or interpret security configuration vulnerabilities in the configuration files of respective cloud computing environment resources utilizing capabilities and/or functionalities such as one or more LLM APIs and the LangChain framework. As used herein, LangChain is an open-source framework designed to simplify the development of applications powered by LLMs. This framework can be used by the generative artificial intelligence agent 212 to invoke one or more generative artificial intelligence APIs and to form one or more prompt templates specific to the LLMs using one or more JavaScript object notation (JSON) files available in the prompt-related data structures 206. Further, such an embodiment can include using a generative artificial intelligence agent to automatically initiate and/or perform one or more mitigation actions and/or steps in response to detecting one or more vulnerable configurations. Automating initiation and/or performance of such mitigation actions can reduce the risk of exploits and/or other data security issues in connection with the cloud computing environment.

Also, one or more embodiments can include customizing automated mitigation processes in accordance with one or more enterprise security standards, wherein such customization can include automatically performing one or more specific mitigation actions in response to one or more particular resource misconfiguration detections. Additionally, as detailed herein, at least one embodiment includes generating and utilizing one or more security configuration evaluation reports, wherein such reports can be incorporated into one or more knowledge bases and/or data structures for use in future security configuration-related operations (e.g., further training and/or fine-tuning of a generative artificial intelligence agent).

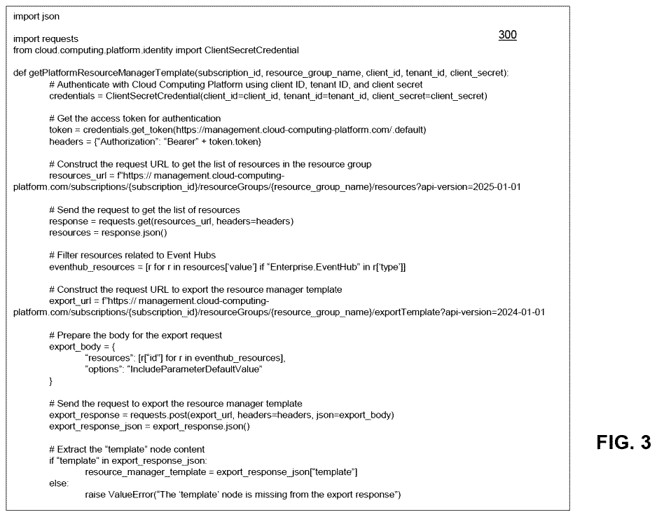

FIG. 3 shows example pseudocode for extracting configuration files from a cloud computing environment in an illustrative embodiment. In this embodiment, example pseudocode 300 is executed by or under the control of at least one processing system and/or device. For example, the example pseudocode 300 may be viewed as comprising a portion of a software implementation of at least part of automated cloud resource configuration modification system 105 of the FIG. 1 embodiment.

The example pseudocode 300 illustrates obtaining an access token for authentication, constructing a request uniform resource locator (URL) to obtain a list of resources in a given resource group, and sending a request to obtain the list of resources. Further, example pseudocode 300 illustrates filtering resources from the list related to one or more resource hubs, constructing a request URL to export a cloud computing environment resource manager template, and preparing for the export request. Additionally, example pseudocode 300 illustrates sending the request to export the cloud computing environment resource manager template, and extracting the corresponding template node content.

It is to be appreciated that this particular example pseudocode shows just one example implementation of extracting configuration files from a cloud computing environment, and alternative implementations can be used in other embodiments.

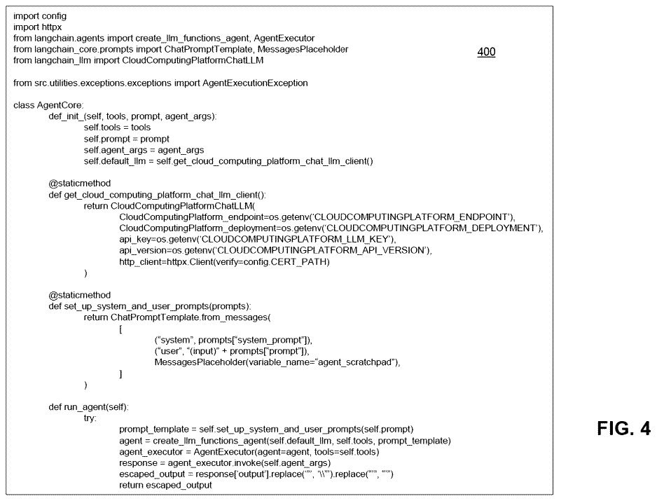

FIG. 4 shows example pseudocode for invoking an LLM API by passing required prompts and configuration file content in an illustrative embodiment. In this embodiment, example pseudocode 400 is executed by or under the control of at least one processing system and/or device. For example, the example pseudocode 400 may be viewed as comprising a portion of a software implementation of at least part of automated cloud resource configuration modification system 105 of the FIG. 1 embodiment.

The example pseudocode 400 illustrates instantiating generative artificial intelligence agent components such as objects to invoke a generative artificial intelligence API, prompt templates to pass prompts to the generative artificial intelligence API, etc. Example pseudocode 400 also defines the method used to invoke the generative artificial intelligence agent by passing one or more required prompts.

It is to be appreciated that this particular example pseudocode shows just one example implementation of invoking an LLM API by passing required prompts and configuration file content, and alternative implementations can be used in other embodiments.

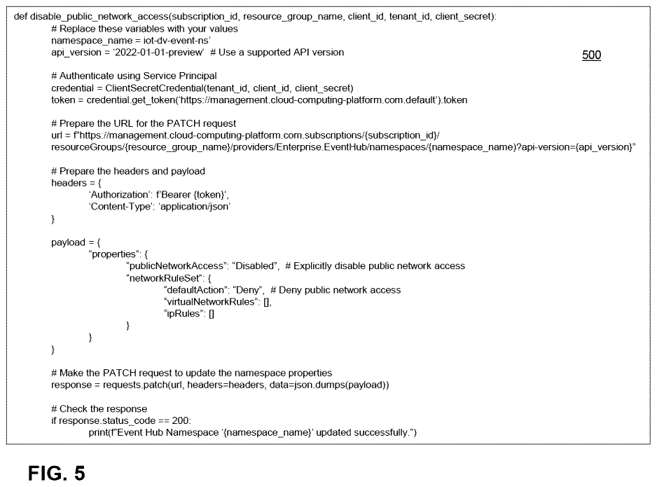

FIG. 5 shows example pseudocode for performing automated configuration mitigation actions in an illustrative embodiment. In this embodiment, example pseudocode 500 is executed by or under the control of at least one processing system and/or device. For example, the example pseudocode 500 may be viewed as comprising a portion of a software implementation of at least part of automated cloud resource configuration modification system 105 of the FIG. 1 embodiment.

The example pseudocode 500 illustrates replacing one or more configuration-related variables with one or more designated values, authenticating using service principal, and preparing the relevant URL for a patch request. Further, example pseudocode 500 illustrates preparing the relevant headers and payload, making the patch request to update one or more namespace properties, and checking the response thereto.

It is to be appreciated that this particular example pseudocode shows just one example implementation of performing automated configuration mitigation actions, and alternative implementations can be used in other embodiments.

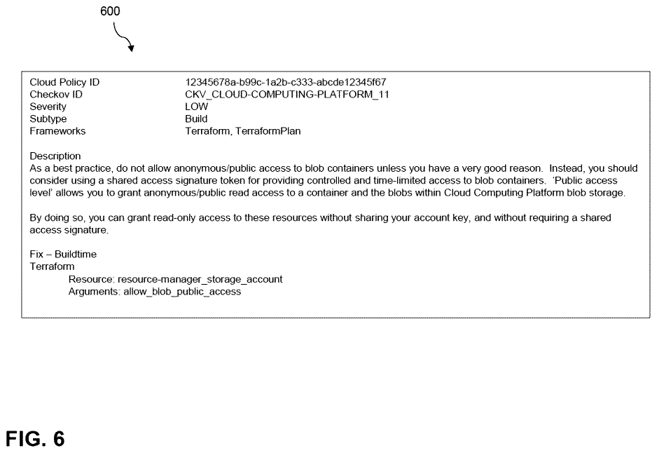

FIG. 6 shows example pseudocode for a presenting a vulnerability assessment generated by a security tool in an illustrative embodiment. In this embodiment, example pseudocode 600 is executed by or under the control of at least one processing system and/or device. For example, the example pseudocode 600 may be viewed as comprising a portion of a software implementation of at least part of automated cloud resource configuration modification system 105 of the FIG. 1 embodiment.

The example pseudocode 600 illustrates a sample security evaluation report which shows a vulnerability related to enablement of public network access of a storage account. Example pseudocode 600 also lists the mitigation steps using Terraform code to fix the issue by disabling public network access.

It is to be appreciated that this particular example pseudocode shows just one example implementation of presenting a vulnerability assessment generated by a security tool, and alternative implementations can be used in other embodiments.

FIG. 7 shows example pseudocode for presenting a vulnerability assessment generated by a generative artificial intelligence agent using at least one LLM in an illustrative embodiment. In this embodiment, example pseudocode 700 is executed by or under the control of at least one processing system and/or device. For example, the example pseudocode 700 may be viewed as comprising a portion of a software implementation of at least part of automated cloud resource configuration modification system 105 of the FIG. 1 embodiment.

The example pseudocode 700 illustrates identification of a security vulnerability in a given cloud computing environment (e.g., the public network access property is set to “enabled,” allowing access to a storage account) and one or more mitigation steps to address the security vulnerability (e.g., set the public network access property to “disabled” to restrict access private networks only).

It is to be appreciated that this particular example pseudocode shows just one example implementation of presenting a vulnerability assessment generated by a generative artificial intelligence agent using at least one LLM, and alternative implementations can be used in other embodiments.

FIG. 8 is a flow diagram of a process for processing security-related configurations of cloud resources using generative artificial intelligence in an illustrative embodiment. It is to be understood that this particular process is only an example, and additional or alternative processes can be carried out in other embodiments.

In this embodiment, the process includes steps 800 through 810. These steps are assumed to be performed by the automated cloud resource configuration modification system 105 utilizing elements 112, 114 and 116.

Step 800 includes obtaining one or more data-related prompts pertaining to at least one cloud computing environment resource. In at least one embodiment, obtaining one or more data-related prompts includes obtaining, from prompt-related data structures, one or more pre-generated prompts related to processing resource-related information from the at least one cloud computing environment.

Step 802 includes accessing data, pertaining to one or more security-related configurations of the at least one cloud computing environment resource, from the at least one cloud computing environment using at least a portion of the one or more data-related prompts. In one or more embodiments, accessing data pertaining to one or more security-related configurations of the at least one cloud computing environment resource includes accessing at least one of one or more human-readable data serialization language templates from the at least one cloud computing environment, one or more cloud computing environment infrastructure templates, and one or more configuration files associated with the at least one cloud computing environment resource.

Step 804 includes obtaining information, designated in at least one data structure associated with the at least one cloud computing environment, attributed to the one or more security-related configurations of the at least one cloud computing environment resource. In at least one embodiment, obtaining information attributed to the one or more security-related configurations of the at least one cloud computing environment resource includes obtaining, from the at least one data structure associated with the at least one cloud computing environment, standard configuration information for the at least one cloud computing environment resource designated by at least one entity associated with operating the at least one cloud computing environment.

Step 806 includes generating, using one or more large language models, at least one security-related configuration assessment of the at least one cloud computing environment resource based at least in part on the accessed data and the obtained information. In one or more embodiments, generating at least one security-related configuration assessment of the at least one cloud computing environment resource includes identifying at least one misconfiguration of at least one of the one or more security-related configurations of the at least one cloud computing environment resource by comparing at least a portion of the accessed data with a corresponding portion of the obtained information.

Step 808 includes determining, based at least in part on processing the at least one security-related configuration assessment using one or more generative artificial intelligence techniques, one or more automated mitigation-related actions related to at least a portion of the one or more security-related configurations of the at least one cloud computing environment resource. In at least one embodiment, determining one or more automated mitigation-related actions includes using the one or more generative artificial intelligence techniques to infer the one or more automated mitigation-related actions in response to the at least one identified misconfiguration.

Step 810 includes automatically modifying the at least a portion of the one or more security-related configurations of the at least one cloud computing environment resource by performing at least part of the one or more automated mitigation-related actions. In one or more embodiments, automatically modifying the at least a portion of the one or more security-related configurations of the at least one cloud computing environment resource includes gaining access to the at least one cloud computing environment and performing the at least part of the one or more automated mitigation-related actions within the at least one cloud computing environment.

In at least one embodiment the techniques depicted in FIG. 8 can also include updating, upon completion of the at least part of the one or more automated mitigation-related actions, the at least one data structure associated with the at least one cloud computing environment with information pertaining to one or more security-related issues identified in the at least one security-related configuration assessment, and information pertaining to the one or more automated mitigation-related actions performed. Such an embodiment can also include automatically training the one or more generative artificial intelligence techniques using at least a portion of the at least one updated data structure associated with the at least one cloud computing environment.

Accordingly, the particular processing operations and other functionality described in conjunction with the flow diagram of FIG. 8 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to process security-related configurations of cloud computing environment resources using generative artificial intelligence and automatically perform configuration mitigation actions related thereto. These and other embodiments can effectively overcome problems associated with reactive processes which are resource-intensive and error-prone.

It is to be appreciated that the particular advantages described above and elsewhere herein are associated with particular illustrative embodiments and need not be present in other embodiments. Also, the particular types of information processing system features and functionality as illustrated in the drawings and described above are examples only, and numerous other arrangements may be used in other embodiments.

As mentioned previously, at least portions of the information processing system 100 can be implemented using one or more processing platforms. A given processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

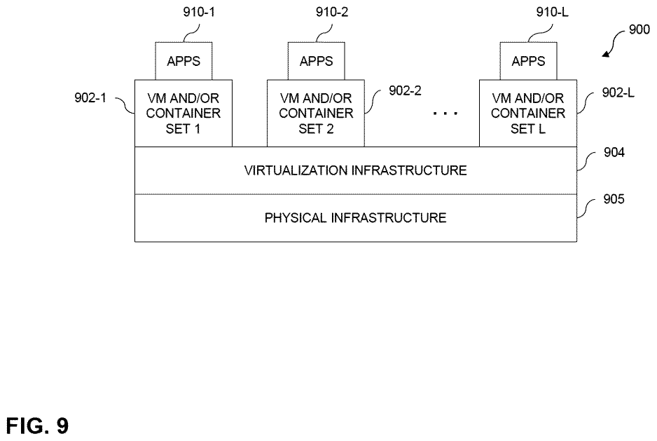

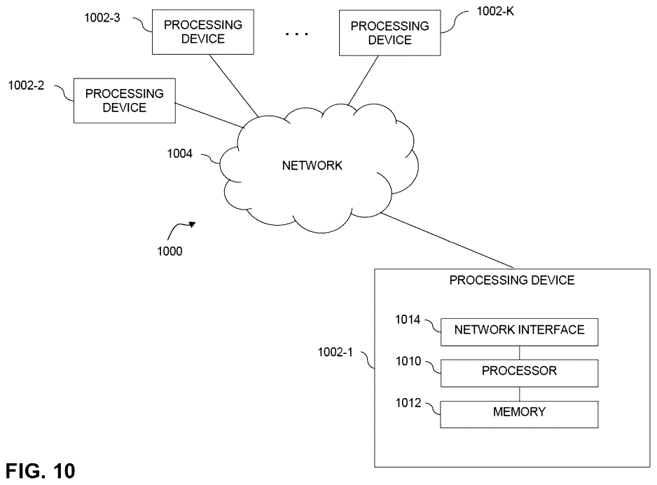

Illustrative embodiments of processing platforms will now be described in greater detail with reference to FIGS. 9 and 10. Although described in the context of system 100, these platforms may also be used to implement at least portions of other information processing systems in other embodiments.

FIG. 9 shows an example processing platform comprising cloud infrastructure 900. The cloud infrastructure 900 comprises a combination of physical and virtual processing resources that are utilized to implement at least a portion of the information processing system 100. The cloud infrastructure 900 comprises multiple virtual machines (VMs) and/or container sets 902-1, 902-2, . . . 902-L implemented using virtualization infrastructure 904. The virtualization infrastructure 904 runs on physical infrastructure 905, and illustratively comprises one or more hypervisors and/or operating system level virtualization infrastructure. The operating system level virtualization infrastructure illustratively comprises kernel control groups of a Linux operating system or other type of operating system.

The cloud infrastructure 900 further comprises sets of applications 910-1, 910-2, . . . 910-L running on respective ones of the VMs/container sets 902-1, 902-2, . . . 902-L under the control of the virtualization infrastructure 904. The VMs/container sets 902 comprise respective VMs, respective sets of one or more containers, or respective sets of one or more containers running in VMs. In some implementations of the FIG. 9 embodiment, the VMs/container sets 902 comprise respective VMs implemented using virtualization infrastructure 904 that comprises at least one hypervisor.

A hypervisor platform may be used to implement a hypervisor within the virtualization infrastructure 904, wherein the hypervisor platform has an associated virtual infrastructure management system. The underlying physical machines comprise one or more information processing platforms that include one or more storage systems.

In other implementations of the FIG. 9 embodiment, the VMs/container sets 902 comprise respective containers implemented using virtualization infrastructure 904 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 900 shown in FIG. 9 may represent at least a portion of one processing platform. Another example of such a processing platform is processing platform 1000 shown in FIG. 10.

The processing platform 1000 in this embodiment comprises a portion of system 100 and includes a plurality of processing devices, denoted 1002-1, 1002-2, 1002-3, . . . 1002-K, which communicate with one another over a network 1004.

The network 1004 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 1002-1 in the processing platform 1000 comprises a processor 1010 coupled to a memory 1012.

The processor 1010 comprises a microprocessor, an ASIC, an SOC, an FPGA, a CPU, a GPU, an NPU, a DPU, a TPU, an ALU, a DSP, and/or other similar processing device components, as well as other types and arrangements of processing circuitry, in any combination. At least a portion of the functionality of at least one artificial intelligence system and its associated artificial intelligence algorithms provided by one or more processing devices as disclosed herein can be implemented using such circuitry.

The memory 1012 comprises RAM, ROM or other types of memory, in any combination. The memory 1012 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1002-1 is network interface circuitry 1014, which is used to interface the processing device with the network 1004 and other system components, and may comprise conventional transceivers.

The other processing devices 1002 of the processing platform 1000 are assumed to be configured in a manner similar to that shown for processing device 1002-1 in the figure.

Again, the particular processing platform 1000 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of an information processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as examples rather than as requirements or limitations of the disclosure. Numerous other alternative embodiments within the scope of the appended claims will be readily apparent to those skilled in the art.

What is claimed is:

1. A computer-implemented method comprising:
obtaining one or more data-related prompts pertaining to at least one cloud computing environment resource;
accessing data, pertaining to one or more security-related configurations of the at least one cloud computing environment resource, from the at least one cloud computing environment using at least a portion of the one or more data-related prompts;
obtaining information, designated in at least one data structure associated with the at least one cloud computing environment, attributed to the one or more security-related configurations of the at least one cloud computing environment resource;
generating, using one or more large language models, at least one security-related configuration assessment of the at least one cloud computing environment resource based at least in part on the accessed data and the obtained information;
determining, based at least in part on processing the at least one security-related configuration assessment using one or more generative artificial intelligence techniques, one or more automated mitigation-related actions related to at least a portion of the one or more security-related configurations of the at least one cloud computing environment resource; and
automatically modifying the at least a portion of the one or more security-related configurations of the at least one cloud computing environment resource by performing at least part of the one or more automated mitigation-related actions;
wherein the method is performed by at least one processing device comprising a processor coupled to a memory.

2. The computer-implemented method of claim 1, wherein generating at least one security-related configuration assessment of the at least one cloud computing environment resource comprises identifying at least one misconfiguration of at least one of the one or more security-related configurations of the at least one cloud computing environment resource by comparing at least a portion of the accessed data with a corresponding portion of the obtained information.

3. The computer-implemented method of claim 2, wherein determining one or more automated mitigation-related actions comprises using the one or more generative artificial intelligence techniques to infer the one or more automated mitigation-related actions in response to the at least one identified misconfiguration.

4. The computer-implemented method of claim 1, wherein accessing data pertaining to one or more security-related configurations of the at least one cloud computing environment resource comprises accessing at least one of one or more human-readable data serialization language templates from the at least one cloud computing environment, one or more cloud computing environment infrastructure templates, and one or more configuration files associated with the at least one cloud computing environment resource.

5. The computer-implemented method of claim 1, further comprising:
updating, upon completion of the at least part of the one or more automated mitigation-related actions, the at least one data structure associated with the at least one cloud computing environment with information pertaining to one or more security-related issues identified in the at least one security-related configuration assessment, and information pertaining to the one or more automated mitigation-related actions performed.

6. The computer-implemented method of claim 5, further comprising:
automatically training the one or more generative artificial intelligence techniques using at least a portion of the at least one updated data structure associated with the at least one cloud computing environment.

7. The computer-implemented method of claim 1, wherein obtaining information attributed to the one or more security-related configurations of the at least one cloud computing environment resource comprises obtaining, from the at least one data structure associated with the at least one cloud computing environment, standard configuration information for the at least one cloud computing environment resource designated by at least one entity associated with operating the at least one cloud computing environment.

8. The computer-implemented method of claim 1, wherein automatically modifying the at least a portion of the one or more security-related configurations of the at least one cloud computing environment resource comprises gaining access to the at least one cloud computing environment and performing the at least part of the one or more automated mitigation-related actions within the at least one cloud computing environment.

9. The computer-implemented method of claim 1, wherein obtaining one or more data-related prompts comprises obtaining, from prompt-related data structures, one or more pre-generated prompts related to processing resource-related information from the at least one cloud computing environment.

10. A non-transitory processor-readable storage medium having stored therein program code of one or more software programs, wherein the program code when executed by at least one processing device causes the at least one processing device:
to obtain one or more data-related prompts pertaining to at least one cloud computing environment resource;
to access data, pertaining to one or more security-related configurations of the at least one cloud computing environment resource, from the at least one cloud computing environment using at least a portion of the one or more data-related prompts;
to obtain information, designated in at least one data structure associated with the at least one cloud computing environment, attributed to the one or more security-related configurations of the at least one cloud computing environment resource;
to generate, using one or more large language models, at least one security-related configuration assessment of the at least one cloud computing environment resource based at least in part on the accessed data and the obtained information;
to determine, based at least in part on processing the at least one security-related configuration assessment using one or more generative artificial intelligence techniques, one or more automated mitigation-related actions related to at least a portion of the one or more security-related configurations of the at least one cloud computing environment resource; and
to automatically modify the at least a portion of the one or more security-related configurations of the at least one cloud computing environment resource by performing at least part of the one or more automated mitigation-related actions.

11. The non-transitory processor-readable storage medium of claim 10, wherein generating at least one security-related configuration assessment of the at least one cloud computing environment resource comprises identifying at least one misconfiguration of at least one of the one or more security-related configurations of the at least one cloud computing environment resource by comparing at least a portion of the accessed data with a corresponding portion of the obtained information.

12. The non-transitory processor-readable storage medium of claim 11, wherein determining one or more automated mitigation-related actions comprises using the one or more generative artificial intelligence techniques to infer the one or more automated mitigation-related actions in response to the at least one identified misconfiguration.

13. The non-transitory processor-readable storage medium of claim 10, wherein accessing data pertaining to one or more security-related configurations of the at least one cloud computing environment resource comprises accessing at least one of one or more human-readable data serialization language templates from the at least one cloud computing environment, one or more cloud computing environment infrastructure templates, and one or more configuration files associated with the at least one cloud computing environment resource.

14. The non-transitory processor-readable storage medium of claim 10, wherein the program code when executed by the at least one processing device further causes the at least one processing device:
to update, upon completion of the at least part of the one or more automated mitigation-related actions, the at least one data structure associated with the at least one cloud computing environment with information pertaining to one or more security-related issues identified in the at least one security-related configuration assessment, and information pertaining to the one or more automated mitigation-related actions performed.

15. The non-transitory processor-readable storage medium of claim 14, wherein the program code when executed by the at least one processing device further causes the at least one processing device:
to automatically train the one or more generative artificial intelligence techniques using at least a portion of the at least one updated data structure associated with the at least one cloud computing environment.

16. An apparatus comprising:
at least one processing device comprising a processor coupled to a memory;
the at least one processing device being configured:
to obtain one or more data-related prompts pertaining to at least one cloud computing environment resource;
to access data, pertaining to one or more security-related configurations of the at least one cloud computing environment resource, from the at least one cloud computing environment using at least a portion of the one or more data-related prompts;
to obtain information, designated in at least one data structure associated with the at least one cloud computing environment, attributed to the one or more security-related configurations of the at least one cloud computing environment resource;
to generate, using one or more large language models, at least one security-related configuration assessment of the at least one cloud computing environment resource based at least in part on the accessed data and the obtained information;
to determine, based at least in part on processing the at least one security-related configuration assessment using one or more generative artificial intelligence techniques, one or more automated mitigation-related actions related to at least a portion of the one or more security-related configurations of the at least one cloud computing environment resource; and
to automatically modify the at least a portion of the one or more security-related configurations of the at least one cloud computing environment resource by performing at least part of the one or more automated mitigation-related actions.

17. The apparatus of claim 16, wherein generating at least one security-related configuration assessment of the at least one cloud computing environment resource comprises identifying at least one misconfiguration of at least one of the one or more security-related configurations of the at least one cloud computing environment resource by comparing at least a portion of the accessed data with a corresponding portion of the obtained information.

18. The apparatus of claim 17, wherein determining one or more automated mitigation-related actions comprises using the one or more generative artificial intelligence techniques to infer the one or more automated mitigation-related actions in response to the at least one identified misconfiguration.

19. The apparatus of claim 16, wherein accessing data pertaining to one or more security-related configurations of the at least one cloud computing environment resource comprises accessing at least one of one or more human-readable data serialization language templates from the at least one cloud computing environment, one or more cloud computing environment infrastructure templates, and one or more configuration files associated with the at least one cloud computing environment resource.

20. The apparatus of claim 16, wherein the at least one processing device is further configured:
to update, upon completion of the at least part of the one or more automated mitigation-related actions, the at least one data structure associated with the at least one cloud computing environment with information pertaining to one or more security-related issues identified in the at least one security-related configuration assessment, and information pertaining to the one or more automated mitigation-related actions performed.
